(19) United States
(12) Patent Application Publication
(10) Pub. No.: US 2021/0174453 A1
(43) Pub. Date: Jun. 10, 2021

(54) MANAGING RISK ASSESSMENT AND SERVICES THROUGH MODELING

(71) Applicant: Cerity Services, Inc., Austin, TX (US)

(72) Inventors: Ryan T. Anderson, Austin, TX (US); Deepak V. Shah, Austin, TX (US); Tracey Lynn Berg, Austin, TX (US); Jonathan D. Sauer, Austin, TX (US); Robert J. Chong, Austin, TX (US)

(21) Appl. No.: 17/113,093

(22) Filed: Dec. 6, 2020

Related U.S. Application Data
(60) Provisional application No. 62/945,151, filed on Dec. 7, 2019.

(51) Int. Cl. G06Q 40/08; G06Q 10/06; G06Q 10/10

(52) U.S. Cl. CPC G06Q 40/08; G06N 20/00; G06Q 10/10; G06Q 10/067

(57) ABSTRACT

A method, system and/or computer usable program product for risk assessment of user activities including receiving a request for a quote for services regarding a user and user activities including receiving first information regarding the user and the user activities; utilizing the first information to automatically identify second information on-line from at least one third party regarding the user; automatically modeling the user and the user activities based on the first information and the second information to assess risks associated with the user and the user activities of undesired events; automatically modeling costs of the assessed risks for providing services covering the undesired events arising from the user activities; and automatically providing the quote for the services covering the undesired events arising from the user activities.

### PRIORITY CLAIM

This application claims priority to U.S. Provisional Application No. 62/945,151, filed Dec. 7, 2019, entitled “MANAGING RISK ASSESSMENT AND SERVICES THROUGH MODELING”, the disclosure of which is incorporated in its entirety herein by reference.

### BACKGROUND

### Technical Field

The present invention relates generally to managing risk assessment and providing services covering that assessed risk through modeling, and more specifically to a computer implemented method of utilizing modeling for identifying and assessing risk for a user based on user and third party provided information and for providing services covering that assessed risk for the user.

### Description of Related Art

Risk Assessment is directed towards identifying and analyzing risk factors for undesired events associated with certain activities which have the potential to negatively impact individuals or businesses, as well as analyzing and evaluating the potential costs associated with those risk factors. Such a risk assessment is typically limited in scope based on the activities and the associated undesired events being assessed. There are many methodologies utilized today for risk assessment, often based on the activities being assessed.

Various types of modeling may be utilized to quantitatively assist in assessing risks for undesired events associated with certain activities and to assist in quantitatively generating quotes for services, such as insurance, that cover the certain activities including the cost of undesired events associated with those activities. Such quantitative modeling typically incorporates historical information as well as incorporating human judgment factors. Such modeling has been difficult to achieve fully reliable results, so human review and possible correction is typically needed on a case by case basis.

### SUMMARY

The illustrative embodiments of the present invention provide a method, system, and/or computer usable program product for risk assessment of user activities including receiving a request for a quote for services regarding a user and user activities including receiving first information regarding the user and the user activities; utilizing the first information to automatically identify second information on-line from at least one third party regarding the user; automatically modeling the user and the user activities based on the first information and the second information to assess risks associated with the user and the user activities of undesired events; automatically modeling costs of the assessed risks for providing services covering the undesired events arising from the user activities; and automatically providing the quote for the services covering the undesired events arising from the user activities.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 provides a block diagram of an illustrative data processing system in which various embodiments of the present disclosure may be implemented;

FIG. 2 provides a block diagram of an illustrative network of data processing systems in which various embodiments of the present disclosure may be implemented;

FIG. 3 provides a high level block diagram of a risk assessment and services system, in which various embodiments of the present disclosure may be implemented;

FIG. 4 provides a high level flow diagram of the operation of the risk assessment and services manager in response to a user inquiry in which various embodiments of the present disclosure may be implemented;

FIG. 5 provides a block diagram of portions of the risk assessment and services manager in which various embodiments of the present disclosure may be implemented;

FIGS. 6A-6B provide high level flow diagrams of the operation of the modeling engine and the performance monitoring engine, respectively, in which various embodiments of the present disclosure may be implemented; and

FIG. 7 provides a high level flow diagram of the operation of the modeling engine, the performance monitoring engine and the model development engine as a feedback loop in which various embodiments of the present disclosure may be implemented.

### DETAILED DESCRIPTION

Processes and devices may be implemented and utilized for managing risk assessment and providing services covering that assessed risk through modeling. These processes and apparatuses may be implemented and utilized as will be explained with reference to the various embodiments below.

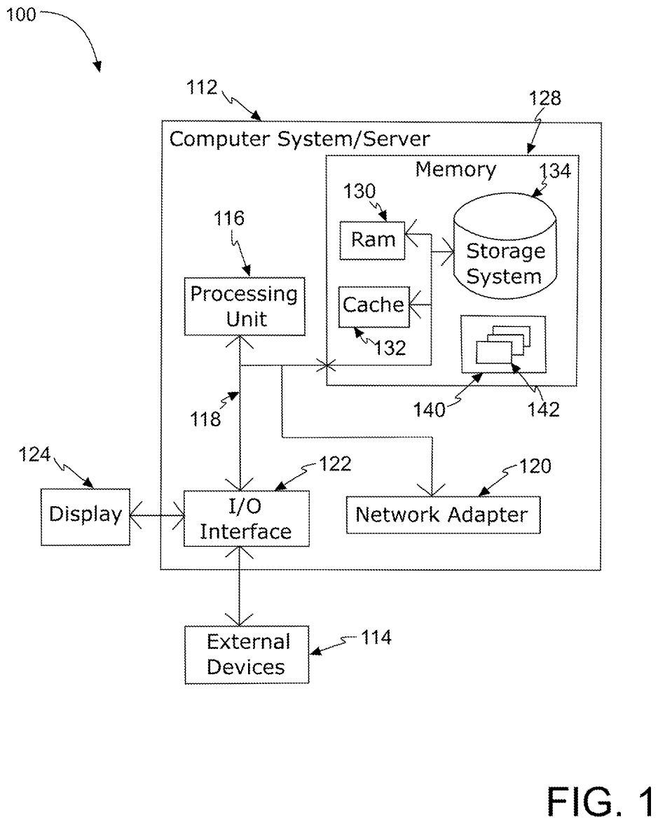

FIG. 1 provides a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as managing risk assessment and providing services covering that assessed risk through modeling.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices. For example, the present invention may be implemented in a cloud computing environment, distributed or otherwise, which may be virtualized such as with the use of a hypervisor managing multiple nodes including virtual processors, virtual memory, etc.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for managing risk assessment and providing services covering that assessed risk through modeling.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

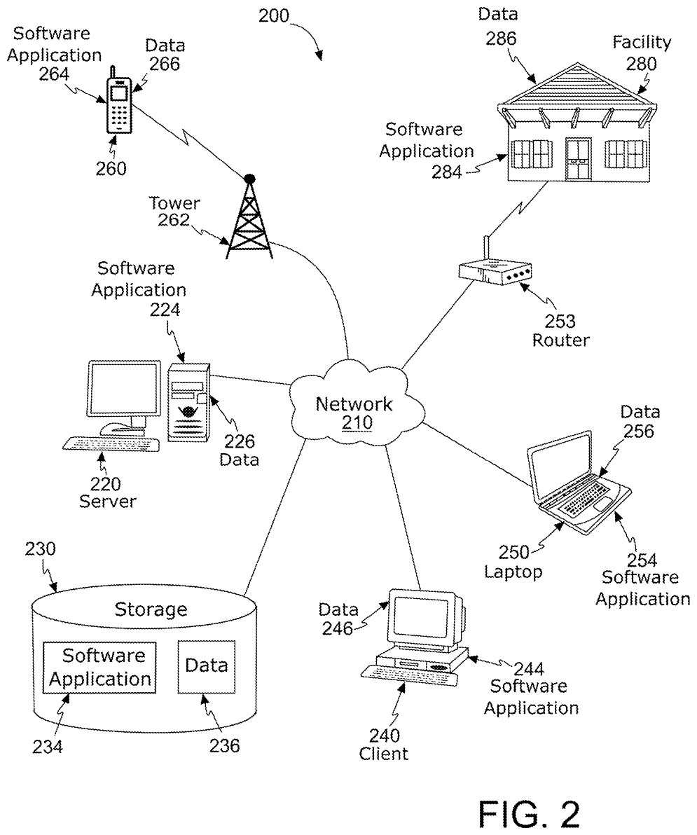

FIG. 2 provides a block diagram of an illustrative network of data processing systems in which various embodiments of the present disclosure may be implemented. Data processing environment 200 is a network of data processing systems such as described above with reference to FIG. 1. Software applications such as for managing risk assessment and providing services covering that assessed risk through modeling may be processed on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile device 260 such as a mobile phone may be coupled to network 210 through a cell tower 262. Data processing systems, such as server 220, client 240, laptop 250, mobile device 260 and facility 280 contain data and have software applications including software tools processing thereon. Other types of data processing systems such as personal digital assistants (PDAs), smartphones, tablets and netbooks may be coupled to network 210.

Server 220 may include software application 224 and data 226 for managing risk assessment and providing services covering that assessed risk through modeling or for other software applications and data in accordance with embodiments described herein. Storage 230 may contain software application 234 and a content source such as data 236 for managing risk assessment and providing services covering that assessed risk through modeling. Other software and content may be stored on storage 230 for sharing among various computer or other data processing devices. Client 240 may include software application 244 and data 246. Laptop 250 and mobile device 260 may also include software applications 254 and 264 and data 256 and 266. Facility 280 may include software applications 284 and data 286 on local data processing equipment. Other types of data processing systems coupled to network 210 may also include software applications. Software applications could include a web browser, email, or other software application for managing risk assessment and providing services covering that assessed risk through modeling.

Server 220, storage unit 230, client 240, laptop 250, mobile device 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile device 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

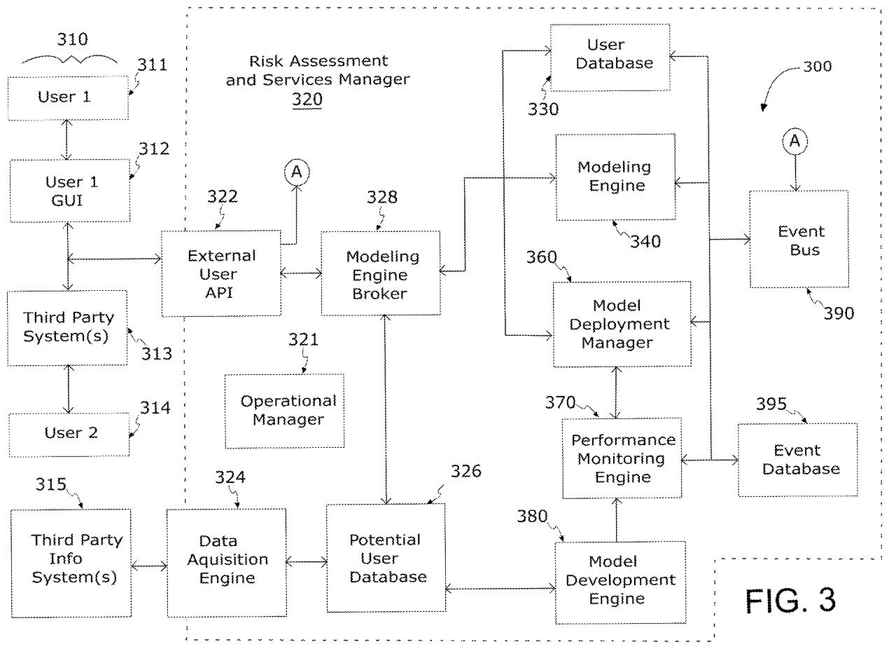

FIG. 3 provides a high level block diagram of a risk assessment and services system, in which various embodiments of the present disclosure may be implemented. Risk assessment and services system 300 includes a risk assessment and services manager 320 automatically interacting with external systems and users 310 through an external user API (Application Programming Interface) 322 and a data acquisition engine 324. In summary, an external user, which may be an entity such as a company, partnership, sole proprietorship or other type of entity that the user represents, is able to interact with risk assessment and services manager 320 through external user API 322 to automatically obtain certain services such as insurance coverage for user identified activities. This includes the user providing information about that user combined with information from third parties for use by the risk assessment and services manager which utilizes models to identify and assess user risk factors associated with the user identified activities and which also utilizes models to generate a quote for services such as insurance coverage for undesired events arising from the user identified activities.

External systems and users 310 includes a user 1 311, user 1 GUI (Graphical User Interface) 312, user 2 312, third party systems 313, and third party information systems 315. User 1 utilizes user 1 GUI for interacting with risk assessment and services manager 310 through external API 322. User 1 GUI may be a webpage or other GUI generally available on the internet for a user to interact with risk assessment and services manager 310. User 1 GUI may be designed specifically for this user interaction and may be part of risk assessment and services manager 320. User 2 utilizes third party system(s) 314 for interacting with risk assessment and services manager 320 through external API 322, similar to user 1 utilizing user 1 GUI as described above. In a preferred embodiment, third party system(s) 314 may implement interactions with user 2 and API 322 natively by utilizing modules or code developed specifically for that purpose. These third party system(s) may be directed to other user needs, interactions and relationships such as bookkeeping, other business management tools, shopping, searching, or even social networking. The risk assessment and services system may be implemented in a cloud environment for ease of implementation and scaling.

External systems and users 310 also includes third party information systems 315 which communicate with data acquisition engine 324. Data acquisition engine 324 may be combined with external user API in alternative embodiments. Third party information systems 315 include a variety of on-line databases and other on-line sources of information, often publicly available, which may be useful for risk assessment and services manager 320. Third party information may include a selective digital footprint of the user (which may also be referred to as firmographics of an entity the user represents) including the user's activities and past history which may be useful for identifying and assessing risks towards providing services for the user identified activities. For example, third party information systems can include secretary of state information regarding an incorporated user, other state provided information regarding the user such as property values, mapping systems that show a location and other information about the user, and even on-line interactions of the user by user's customers, suppliers and other persons or entities that interact with the user. This third party information can be gathered, aggregated and stored as records in potential user database 326 by data acquisition engine 324, prior to the user providing any information. This allows for quick access and use when a user provides enough information to associate with one or more records of information in potential user database 326. This third party information can also be gathered or supplemented by data acquisition engine 324 from third party information systems 315 in real time as needed based on user provided information such as the user's name and location.

Risk assessment and services manager 320 includes operational manager 321, external user API 322, data acquisition engine 324, potential user database 326, modeling engine broker 328, user database 330, modeling engine 340, model deployment manager 360, performance monitoring engine 370, model development engine 380, event bus 390, and event database 395. User 1 GUI 312 may also be designed specifically for and part of risk assessment and services manager 320. Risk assessment and services manager 320 may utilize all of these elements for modeling a user's profile, including risk factors for assessing risk associated with that user's identified activities, and for utilizing a model for quoting certain services such as insurance coverage for those user identified activities based on the modeled user profile. Operational manager 321 manages the internal operations of risk assessment and services manager 320. That is, certain actions taken by various elements of the risk assessment and service manager may need coordination, prompting or other instructions needed for proper operation, which is handled by operational manager 321.

Modeling engine broker 328 manages certain information exchanged between user 1 or user 2 with modeling engine 340 which may be supplemented with information from user database 330 or potential user database 326. Third party system(s) 313 may also provide additional information regarding user 2 from information previously obtained from that user by that third party system. For a new user, information provided by that user, such as the user's name and primary location, may be associated with information regarding that user from potential user database 326 to modeling engine 340 for risk assessment. If there is a lack of information in potential user database 326, then data acquisition engine 324 may seek additional information regarding the user from third party information system(s) 315. For a preexisting user, identifying information provided by the user, such as a user identifier and password, may be associated with information regarding that user from user database 330 to modeling engine 340 for a variety of purposes as described below. In addition, additional information may be obtained from potential user database 326 and data acquisition engine 324 as needed or as a matter of periodically updating user database 330.

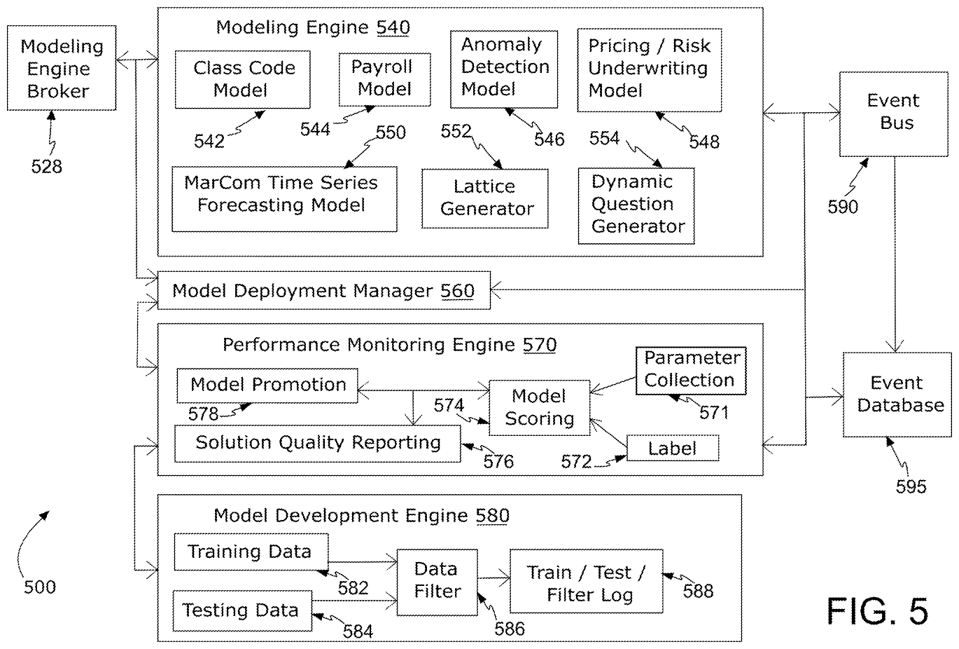

In this embodiment, modeling engine 340 may be the center of operations of risk assessment and services manager 320. That is, the other elements may be for supporting the operations of modeling engine 340, either for a current user interaction or for improving the operation of modeling engine 340 over time. As explained below with reference to FIG. 5, modeling engine 340 may utilize several different models for assessing risks including classifying risks related to the user's activities, for detecting anomalies, for pricing towards providing a quote for services, etc. As explained below with reference to FIG. 5, new or updated models may be developed in model development engine 380, tested against current models utilizing live data by performance monitoring engine 370, and then deployed by model deployment manager 360.

Event based communications may be handled by event bus 390 between user database 330, modeling engine 340, model deployment manager 360, performance monitoring engine 370 as well as external user API 322. All event based communications or a derivative thereof may be stored in event database 395 for subsequent use as needed by model development engine 380 or by any of the other elements that utilize event bus 390. In this embodiment, events are interactions between the user and risk assessment and services manager 320. Events may be bidirectional, either from the user to the risk assessment and services manager or the reverse. Any other communications on the event bus may be deemed to be non-events in this embodiment. Updates to the user database that include corrections or adjustments to a user's entry in that database may also be deemed an event. For example, it may be later determined that the user's payroll was larger than previously determined such as through the user providing actual payroll documentation, through an audit, or other review of a user's payroll. A correction to the user database reflecting this may be considered an event that is captured in event database 395. This allows for the system to assess and score any previous results of a payroll model based on this updated information. In alternative embodiments, for a detailed audit trail, events may also include any communications between each of the risk assessment and services elements on the bus or even communications within a single element such as interactions between models in modeling engine 340. For example, in this embodiment, an inquiry from a user to the risk assessment and services manager for services, a request from the risk assessment and services manager to the user for additional information about that user, and a quote provided from the risk assessment and services manager to the user may each be an event communicated on event bus 390 and stored in event database 395. However, in this embodiment, any other communications on the event bus may be deemed as non-events and not stored on event database 395. In alternative embodiments, an event such as a user inquiry for services may prompt additional events such as an update to the user database 330 by modeling engine 340, a request for the latest deployed models from modeling engine 340 to model deployment manager 360, etc., each of which may be saved in event database 395.

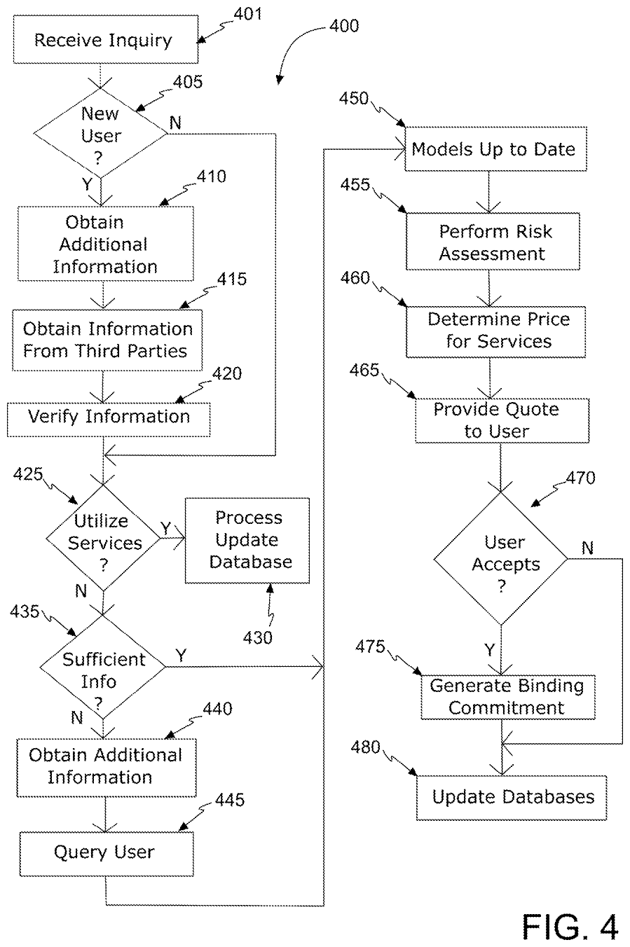

FIG. 4 provides a high level flow diagram 400 of the operation of the risk assessment and services manager in response to a user inquiry in which various embodiments of the present disclosure may be implemented. FIG. 4 is described below with the embodiment described with reference to FIG. 3 above. In a first step 401, risk assessment and service manager 320 receives an inquiry for services from a user. In this embodiment, this inquiry may be from user 1 through user 1 GUI or from user 2 through a third party system. This inquiry could be a request to obtain certain services such as insurance coverage for user identified activities, a request to maintain, update or utilize previous obtained services (e.g., file an insurance claim), or a request to manage payments for such services. In this embodiment, the risk assessment and services manager may automatically utilize models to identify and assess user risk factors associated with the user identified activities and also utilize models to provide a binding quote for services such as insurance coverage for undesired events arising from the user identified activities towards obtaining an acceptance of that quote and payment for the services, all without human intervention other than possibly the inquiring user. Alternative embodiments may include other types of inquiries. For example, a third party service provider may automatically pass through certain user information for subcontracting part or all of the services such as insurance or reinsurance. In another embodiment, a user may be identified and a quote generated for that user based on the user's digital footprint for providing an unsolicited quote for services to that user. This allows for direct marketing to potential users with binding quotes for services.

In a second step 405, it is determined whether the user is a new user. The user may self-identify as a return user by using a user identifier (user id) with a password or other verifiable information such as biometrics. Alternatively, the user may provide the user's name and/or other identifying information which may be searched against the user database and verified with the user. If yes (the user is a new user), then processing continues to step 410, otherwise processing continues to step 425. In step 410, additional information may be obtained regarding the new user to help uniquely identify that user, which may be an entity such as a company, partnership, sole proprietorship or other type of entity that the user represents. This can include the name of the user, the principal address of the user (e.g., the primary place of business of an entity that the user represents), the user's IP (Internet Protocol) address, IP provider, metadata, etc. This information may be obtained directly from the user or from the system that the user is utilizing for communicating with the risk assessment and services manager. Once this unique identifying information is obtained, an entry or record may be generated in the user database including this identifying information. The user may also select or be provided a user id and password or other method to reference that user database entry in the future.

Then in step 415, additional information regarding the identified user may be obtained from potential user database 326. This information may have been retrieved, aggregated, updated and stored earlier by data acquisition engine 324 from a variety of on-line sources. This additional information may include a selective digital footprint of the user (which may also be referred to as firmographics of an entity the user represents) including the user's activities and past history which may be useful for identifying and assessing risks towards providing services for the user identified activities. For example, third party information systems can include secretary of state information regarding an incorporated user, other state provided information regarding the user such as property values, mapping systems that show a location and other information about the user, and even on-line interactions of the user by user's customers, suppliers and other persons or entities that interact with the user. If insufficient or no information is available from the potential user database, then data acquisition engine 324 may be instructed to pursue obtaining additional information using information obtained from the user. Such information may be insufficient if it cannot be easily associated with the new user. Subsequently in step 420, the user may be queried to verify and/or supplement the information gathered in steps 410 and 415 to verify the unique identification and other information regarding that user. This information may be used to update the user entry or record in the user database. Processing then continues to step 425 in combination with a no answer in step 405 above.

In step 425, it is determined whether the inquiry is to add, maintain or update services or to utilize previously obtained services. If the inquiry is to add, maintain or update services, then processing continues to step 435. If the inquiry is directed to utilizing previously obtained services (e.g., filing a claim), then the user may be directed to an automated or human intervention system 430 for that purpose. However, in step 430, this utilization of services may be used to updated the user database so that any future risk assessment and services may be reassessed based on the services requested and provided in step 430. If the inquiry is not only to utilize previously acquired services, but to also add, maintain or update services, then processing continues to step 435, otherwise processing may cease in the this described process after step 430.

In step 435, it is determined whether there is sufficient information regarding the user and user's identified activities to automatically provide an up to date risk assessment and quote in response to the inquiry for services. If yes in step 435, then processing continues to step 450, otherwise processing continues to step 440. In step 440, additional information regarding the user and the user's defined activities are obtained from potential user database 326, which may be utilized to update an entry regarding the user in the user database. This information may have been retrieved, aggregated, updated and stored earlier by data acquisition engine 324 from a variety of on-line sources. If insufficient or no information is available from the potential user database, then data acquisition engine 324 may be instructed to pursue obtaining additional information using information obtained from the user. Subsequently in step 445, the user may be queried to verify and/or supplement the information gathered in step 440 so that the information may be sufficient to automatically provide the risk assessment and quote in response to the inquiry for services. If insufficient data to automatically provide a risk assessment and quote, then the user's data may be supplemented with a set of generic information from other sources, referred to herein as lattice information. That is, from the information gather from the user such as the user's type of business and general size, general industry data may be utilized to supplement the user's data. Such general industry data is typically anonymized and aggregated in a hierarchical or lattice format and can be utilized as needed to complete a general profile of the user suitable for automatically providing a risk assessment and binding quote. Processing then continues to step 450 in combination with a yes answer in step 435 above.

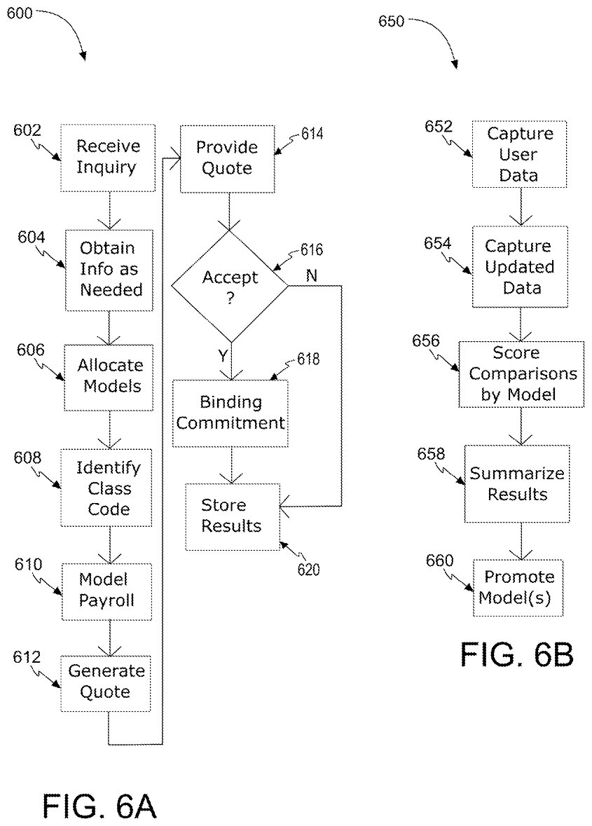

The following steps 450 through 460 are described in greater detail below with reference to FIGS. 5 and 6A. In step 450, model deployment manager 360 verifies that the models being utilized by modeling engine 340 are up to date for the user and for the user inquired services. For example, different models may be utilized for the jurisdiction the user is located in, the type of business of the user, and the type of services the user is inquiring about. If the models being utilized by the modeling engine are not up to date, then the models being utilized by modeling engine 340 are updated automatically by model deployment manager 360. Then in step 455, a risk assessment of the user and user's identified activities for the user inquired service is performed by modeling engine 340, whether the inquiry is for obtaining, maintaining or updating those services. This includes classifying or reclassifying the user and the user's activities for the type of services and obtaining a risk score associated with that classification. Then in step 460, a pricing model is utilized by modeling engine 340 to determine an appropriate price to quote to the user for the user inquired services based on the type of services requested, the risk score for that user, and other factors such as the location of the user (or the entity the user represents). This can include a determination that the risk is too high for providing the user inquired service, or that significant anomalies occurred during the above described process that additional screening is required, typically by a human, before a quote can be given. Then in step 465, the quote for the user requested services is provided to the user for review and possible acceptance. In step 470, it is determined whether the user has accepted to quote. If yes, then processing continues to step 475, otherwise processing continues to step 480. In step 475, a binding commit of the quoted services is generated and payment or a commitment for payment is obtained from the user. Then in step 480, user database is updated with the results of steps 450 through 475. This includes an audit trail of the above steps for use as needed. This storage of the classification, risk assessment, and pricing information also allows for later subsequent utilization by the user in the future. For example, if the user had not accepted the quote for services, this allows that user to revisit the quote for possible acceptance at a later date, although the quote may be updated using any additional information gleaned by data acquisition engine 324, by additional or improved information obtained about the user, by an improvement in the models utilized for risk assessment and quotation, etc.

Additional steps may be taken to maintain the accuracy of the modeling engine. For example, the performance monitoring engine may apply the same data being provided to the modeling engine against other models, such as potential future versions of those models. This may be accomplished concurrent with steps 450 through 460 above, or it may be accomplished at a later time by utilizing information stored in the user database and the event database. This allows for real-time or near real-time statistical testing of alternative models towards utilizing the best of breed models for a given user profile and type of service. In addition, multiple models may be utilized concurrently to perform a risk analysis and quotation. The results of the multiple models may be filtered to remove any outlier results and then combined such as by a weighted average based on prior experience with the models. This process is described in greater detail below with reference to FIGS. 5 and 6B. Furthermore, new models may be generated and tested in model development engine 380. After initial training and testing of these newly generated models, they may be moved to performance monitoring engine 370 for additional testing against the same data being provided to the modeling engine.

FIG. 5 provides a block diagram 400 of portions of the risk assessment and services manager in which various embodiments of the present disclosure may be implemented. In particular, more detail is provided of modeling engine 540, model deployment manager 560, performance monitoring engine 570, and model development engine 580 automatically interacting with modeling engine broker 528, event bus 590 and event database 595. All of these elements of FIG. 5 have similar numbers to corresponding elements of FIG. 3. In this embodiment, the risk assessment and services manager may automatically utilize models to identify and assess user risk factors associated with the user identified activities and also utilize models to provide a binding quote for services such as insurance coverage for undesired events arising from the user identified activities towards obtaining an acceptance of that quote and payment for the services, all without human intervention other than the inquiring user. Alternative embodiments may include other types of inquiries. For example, a third party service provider may automatically pass through certain user information for subcontracting part or all of the services such as insurance or reinsurance. Modeling engine 540 and the elements thereof may be implemented in a hardware environment with specialized hardware optimized for deep learning (such as TensorFlow chips) or other types of specialized hardware or software so that the models can learn and respond without human intervention. Modeling engine 540 and the elements thereof may also be implemented in a cloud environment with the use of specialized virtual processors optimized for deep learning or other virtual applications so that the models can learn and respond without human intervention.

Modeling engine broker 528 manages certain information exchanged between an external user, which may be an entity such as a company, partnership, sole proprietorship or other type of entity that the user represents, with modeling engine 540 which may be supplemented with information from a user database or a potential user database. Third party system(s) may also provide additional information regarding the user from information previously obtained from that user by that third party system. For a new user, information provided by that user, such as the user's name and primary location, may be associated with information regarding that user from the potential user database to modeling engine 540 for risk assessment. If there is a lack of information in the potential user database, then the data acquisition engine may seek additional information regarding the user from third party information system(s). For a preexisting user, identifying information provided by the user, such as a user identifier and password, may be associated with information regarding that user from a user database to modeling engine 540 for a variety of purposes as described below. In addition, additional information may be obtained from the potential user database and the data acquisition engine as needed or as a matter of periodically updating user database.

Event based communications may be handled by event bus 590 between modeling engine 540, model deployment manager 560 and performance monitoring engine 570. All event based communications or a derivative thereof may be stored in event database 595 for subsequent use as needed by model development engine 580 or by any of the other elements that utilize event bus 590. In this embodiment, events are interactions between the user and risk assessment and services manager 520. Events may be bidirectional, either from the user to the risk assessment and services manager or the reverse. Any other communications on the event bus are deemed to be non-events in this embodiment. In alternative embodiments, for a detailed audit trail, events may also include any communications between each of the risk assessment and services elements on the bus or even communications within a single element such as interactions between models in modeling engine 540. For example, in this embodiment, an inquiry from a user to the risk assessment and services manager for services, a request from the risk assessment and services manager to the user for additional information about that user, and a quote provided from the risk assessment and services manager to the user may each be an event communicated on event bus 590 and stored in event database 595. However, in this embodiment, any other communications on the event bus may be deemed as non-events and not stored on event database 595. In alternative embodiments, an event such as a user inquiry for services may prompt additional events such as an update to the user database 530 by modeling engine 540, a request for the latest deployed models from modeling engine 540 to model deployment manager 560, etc., each of which may be saved in event database 595.

Modeling engine 540 may be the center of operations of the risk assessment and services manager 520. That is, the other elements may be for supporting the operations of modeling engine 540, either for a current user interaction or for improving the operation of modeling engine 540 over time. Modeling engine 540 may be invoked by a user inquiry such as described above with reference to FIG. 4, or it may be invoked at other times to perform a risk assessment and service pricing. For example, modeling engine may be invoked at every payment cycle of a service provided to a user to reassess the risk involved and the price charged for that service. This is often referred to as a “pay as you go” approach to providing services such as insurance coverage.

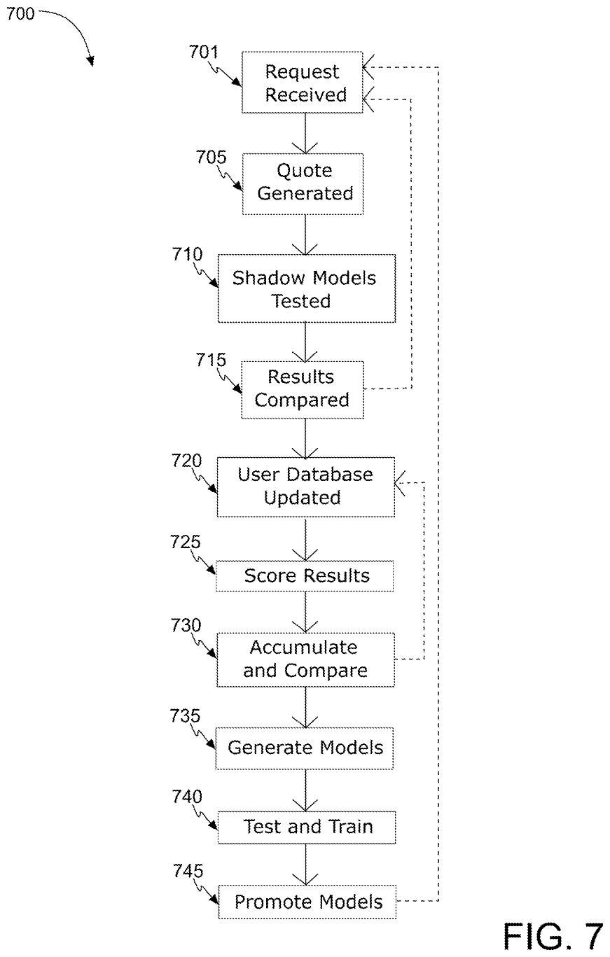

Modeling engine 540 may utilize several different types of models for performing various parts of assessing risks and service pricing. For example, different types of models may be deep learning or ensemble, stochastic or deterministic, etc. As will be explained below, various types of models can be developed and tested over time to continuously improve or replace the models utilized in a production environment. In addition, different types of models may be utilized for the various functions of the modeling engine based on the user profile or the type of service the user may be inquiring about. That is, such as described with reference to FIG. 7 below, multiple models may be developed, trained and initially tested in model development engine 580, then tested with live production data as shadow models in performance monitoring engine 570, with the results compared over time against other the other shadow models as well as the production models. This comparison of results can result in production models being replaced by shadow models that have statistically significant better results over time. Based on this process and the learnings of which models perform best over time, better models can be developed, trained and initially tested in model development engine 580 and the process of testing and replacing models repeated. This is a feedback loop that can result in a continuously improving process of assessing risks and quoting services to cover the assessed risks.

Modeling engine 540 may include a class code model 542, payroll model 544, anomaly detection module 546, pricing/risk underwriting model 548 and MarCom (marketing communications) time series forecasting model 550. Also included is a lattice generator 552 and a dynamic question generator 554. When modeling engine 540 is invoked for performing a risk assessment and service pricing, each of these models and generators may be utilized to obtain the desired results as described with reference to FIG. 6A below.

Class code model 542 is utilized to classify the user and the user's activities for the type service requested. For example, if the user is requesting a quote for worker's compensation insurance, this model would classify the user's type of business for making an assessment of the general risk involved with respect to the entity the user represents. This type of business may be classified as warehousing and shipping, yard service, manufacturing, fast food service, etc., each with a different class code and associated range of risk associated with that type of business. This classification of the user and the user's business is vitally important for an accurate risk assessment and service quoting. Inaccuracies in classification could have a direct impact on the ability of an owner or supplier of the risk assessment and services system to sustainably provide services. The class codes utilized for classifying the user's activities may be a custom set of class code useful for statistical analysis of risk associated with each class code. In addition, such a custom set of class codes may be mappable against any class codes promulgated and expected by various jurisdictions which may regulate the services provided to the user. Class code model 542 may also identify mistakes or misrepresentation of the user's type of business by the user. For example, the user may identify itself as an electronics retailer and not mention that the user also retails fireworks, which is a higher risk type of business and activity and may be too high of a risk for providing services for the user. Class code model 542 may search the digital footprint of the user to identify such discrepancies.

Payroll model 544 models the payroll of a user entity, which may be useful in assessing risk for the user's activities. That is, the number of employees and how much they are paid can affect the level of risk for providing services such as insurance. The payroll model may focus on various assessments of the volume and revenue of user's activities from user's digital footprint (which may also be referred to as firmographics of an entity the user represents) to ascertain the payroll of the user, the type of business and/or profession such as the classification of the user from class code model 542, and the location of the user due to jurisdictional variations such as minimum wage differences. Similar to class code model 542, payroll model 544 may also identify mistakes or misrepresentation of the user's type of business by the user.

Anomaly detection model 546 watches for and identifies anomalies in the user's profile as well as how the user interacts with the risk assessment and services manager. For example, the number of employees may not match the user's type of business, the user may modify the same input multiple times to obtain different results which can indicate false entries, etc. When the number, breadth or overall concern of anomalies reaches a threshold, then the user may not receive a quote for services until those anomalies have been reviewed and accepted, which may involve human intervention. Anomaly detection model 546 may also watch for and identify anomalies in the various models in the modeling engine and even the performance monitoring engine. That is, anomaly detection model 546 may identify sudden changes in model performance or outlier results that indicate that human intervention to review these issues may be warranted. For example, if an ensemble model is being utilized for determining payroll, a wide variation in the result of various models being utilized may indicate a low confidence in the ensemble results, warranting human intervention to determine whether there are issues with the models or with the information that was gathered regarding the user and the user's business.

Pricing/risk underwriting model 548 may utilize the results of the class code model and the payroll model as well as other information to generate a quote for providing certain services for the user. That is, the combination of the class code model, the payroll model and the anomaly detection model can be combined into an overall risk score of the user and the user's activities for the inquired services. The risk score is then bucketed into tiers, each tier having a general range of prices. The risk score and associated tier can then be combined with other factors such as the user's location to generate a quote for the inquired services. The user's location may be important due to a variety of factors including jurisdictional laws, regulations and costs relative to that jurisdiction.

MarCom time series forecasting model 550 analyzes time series data of marketing and communications in combination with services quoted, sold and maintained in order to extract meaningful statistics and other characteristics of that time series data. For example, a marketing campaign may result in a higher number of quotes that do not result in sales or which result in providing services to user's that were higher risk than what was assessed for those users. For another example, the number of quotes provided to users in a given jurisdiction or class code may be compared to the number of acceptances of those quotes as well as the number of subsequent renewals to determine the conversion and retention rates for the jurisdiction or class code. Other data mining of this information, including the user digital footprint, may be utilized to identify types of users which may be approached through directed marketing campaigns. This could include pre-quoting the cost of services to a potential users based on that user's digital signature. That is, a user may be identified and a quote generated for that user based on the user's digital footprint for providing an unsolicited quote for services to that user. This allows for direct marketing to potential users with binding quotes for services.

Lattice generator 552 is utilized to search for and provide generic information from a variety of sources to complete a general profile of the user suitable for automatically providing a risk assessment and binding quote. That is, information gathered from the user such as the user's type of business, location, and general size may be utilized to identify general industry data (i.e., lattice information) which may be utilized to supplement the user's data. Such general industry data is typically anonymized and aggregated in a hierarchical or lattice format and can be utilized as needed to complete a general profile of the user suitable for automatically providing a risk assessment and binding quote. Class code model 542, payroll model 544 and pricing/risk underwriting model 548 may each utilize data from the lattice generator as needed. Likewise, shadow models from performance monitoring engine 570 may also utilize lattice generator 552 or a shadow version of the lattice generator. As explained in greater detail below, shadow models are non-production models being tested utilizing production data for comparison with the production models utilized in model engine 340.

Dynamic question generator 554 is used for identifying whether insufficient information is available for the various models including model deployment 560 and then generating and providing questions to a user as needed to obtain desired information from that user that is needed for running these models. That is, for certain detailed information, the user needs to be questioned in a manner that the user provides the needed information accurately. This can be accomplished algorithmically, such as with generative models, without human intervention in real-time. Dynamic question generator may interact with model deployment manager 560, class code model 542, payroll model 544 and pricing/risk underwriting model 548 as well as any other models which may need additional information regarding the user for risk assessment and service quotation. As explained below with reference to FIG. 6B, new or updated models may be developed in model development engine 580, tested against current models utilizing live data by performance monitoring engine 570, and then deployed by model deployment manager 560. Model deployment manager 560 verifies that the models being utilized by modeling engine 540 are up to date for the user and for the user inquired services. For example, different models may be utilized for the jurisdiction the user is located in, the type of business of the user, and the type of services the user is inquiring about. If the models being utilized by the modeling engine are not up to date, then the models being utilized by modeling engine 540 are updated automatically by model deployment manager 560.

Performance monitoring engine 570 is utilized to continue training and testing alternative models not yet in production (also referred to herein as shadow models) with the same data utilized by the production models of modeling engine 540. The results of this testing can be compared between the shadow models as well as against the production models. This can allow for identifying shadow models which may be ready for use in production as well as identifying possible performance issues with the production models. This allows for a comparison of results of the shadow models against the production models. Performance monitoring engine 570 includes parameter collection 571, label collection 572, alternative model scoring 574, solution quality reporting 576 and model promotion 578. Parameter collection 571 includes user data as obtained upon a user inquiry, whereas label collection includes updated user data that is more definitive. For example, a user may claim to have a certain number of employees and each shadow payroll model may adjust that (likely in differing amounts of adjustment for each model) based on other data such as from the potential user database—this would be considered part of parameter collection 571. However, a later assessment of the user such as through an audit or other more definitive technique may yield a more definitive accounting of the user payroll—this would be considered part of label collection 572. The differences between these would be one sample utilized for scoring the shadow models against each other and against the production models by shadow model scoring 574. Over time, this scoring could be summarized by solution quality reporting 576 for use in identifying whether a current production model may be degrading over time and whether a shadow model may be performing better than a production model. In such a case, a shadow model may be promoted by model promotion 578 to the production environment by model deployment manager 560. In summary, this process of reviewing the ongoing performance of the production models against shadow models is a feedback loop that provides an automated system of modeling risk and pricing for services that can continuously improve over time with more experience.

Model development engine 580 is utilized to develop models for possible future training and testing as shadow models by performance monitoring engine 570 and possible use in production by modeling engine 540. Model development engine 580 includes training data 582, testing data 584, data filter 586, and train/test/filter log 588. In summary, training data 582 and testing data 584 are filtered by data filter 586 for training and testing a newly developed model, all of which is maintained in a train/test/filter log 588. In this process, the training data, the test data, and the type of filtering may be varied over time or different versions of those may be utilized for different versions of a newly developed model. This allows for great flexibility in developing, training and testing models while maintaining an audit trail of that process.

FIGS. 6A-6B provide high level flow diagrams of the operation of the modeling engine and the performance monitoring engine, respectively, in which various embodiments of the present disclosure may be implemented. These flow diagrams illustrate how the risk assessment and service manager utilizes feedback and continuous self-checking in a dynamic environment to provide an automated system of modeling risk and pricing for services that can continuously improve over time with more experience.

FIG. 6A provides a high level flow diagram 600 of the operation of the modeling engine in which various embodiments of the present disclosure may be implemented. FIG. 6A is described below with the embodiment described with reference to modeling engine 540 of FIG. 5 above. For purposes of simplifying the description below, there is no differentiation between a new or returning customer. Also, anomaly detection model 546 may run continuously throughout much of the below process for identifying anomalies in the user's profile as well as how the user interacts with the risk assessment and services manager.

In a first step 602, an inquiry for services is received from a user, which may be an entity such as a company, partnership, sole proprietorship or other type of entity that the user represents. This inquiry could be a request to obtain certain services such as insurance coverage for user identified activities, a request to maintain, update or utilize previous obtained services (e.g., file an insurance claim), or a request to manage payments for such services. In this embodiment, the modeling engine may automatically utilize models to identify and assess user risk factors associated with the user identified activities and also utilize models to provide a binding quote for services such as insurance coverage for undesired events arising from the user identified activities towards obtaining an acceptance of that quote and payment for the services, all without human intervention other than possibly the inquiring user. Alternative embodiments may include other types of inquiries. For example, a third party service provider may automatically pass through certain user information for subcontracting part or all of the services such as insurance or reinsurance. In step 604, the system (e.g., the dynamic question generator) identifies whether there is sufficient information about the user to identify the appropriate models to be utilized for risk assessment and service quotation and then seeks that information as needed. This could include the type of service the user is inquiring about (e.g., worker's compensation insurance) and the location where the user needs the service. This is because different models may be utilized for different types of services and for different jurisdictions (which may have different laws and regulations that need to be taken into account within a model). Alternative embodiments may utilize other types of factors for identifying the appropriate type of models for risk assessment and service quoting. If there is insufficient information, additional information may be sought from the potential user database or from the user. The user may simply be given a set of choices for selection by dynamic questions generator 552.

Then in step 606, model deployment manager 560 identifies the appropriate models for allocation to modeling engine 540 for the user inquiry based on the services requested by the user and the location of the user in the present embodiment. If those models are not currently loaded in modeling engine 540 for use, then they will be uploaded and/or updated as needed for allocation. Model deployment manager 560 will then instruct modeling engine 540 which models to utilize for this given user inquiry.

In step 608, class code model 542 then identifies the type of business and associated class code for the user. This can be determined from any user provided information, information from the potential user database that may have been confirmed by the user, as well as any associated digital footprint of the user. If insufficient information is available to confidently make a determination of the user's class code, then the user may receive an inquiry for additional information through dynamic question generator 554 or general industry data (i.e., lattice information) which may be utilized to supplement the known data about the user. Class code model 542, along with anomaly detection model 548, may also identify mistakes or misrepresentation of the user's type of business by the user. For example, the user may identify itself as a lawn service provider and not mention that the user also does tree removal, which is a higher risk type of business and activity and may be too high of a risk for providing services for the user.

Once the class code has been identified, then in step 610 payroll model 544 may model the payroll of a user entity, which may be useful in assessing risk for the user's activities. That is, the number of employees and how much they are paid can affect the level of risk for providing services such as insurance. The payroll model may focus on various assessments of the volume and revenue of user's activities from user's digital footprint (which may also be referred to as firmographics of an entity the user represents) to ascertain the payroll of the user, the type of business and/or profession such as the classification of the user from class code model 542, and the location of the user due to jurisdictional variations such as minimum wage differences. Similar to class code model 542, payroll model 544, along with anomaly detection model 548, may also identify mistakes or misrepresentation of the user's type of business by the user.

Then in step 612, pricing/risk underwriting model 548 may utilize the results of the class code model and the payroll model as well as other information to generate a quote for providing certain services for the user. That is, the combination of the class code model, the payroll model and the anomaly detection model can be combined into an overall risk score of the user and the user's activities for the inquired services. The risk score is then bucketed into tiers, each tier having a general range of prices. The risk score and associated tier can then be combined with other factors such as the user's location to generate a quote for the inquired services. The user's location may be important due to a variety of factors including jurisdictional laws, regulations and costs relative to that jurisdiction.

Then in step 614, the quote for the user requested services is provided to the user for review and possible acceptance. In step 616, it is determined whether the user has accepted to quote. If yes, then processing continues to step 618, otherwise processing continues to step 620. In step 618, a binding commit of the quoted services is generated and payment or a commitment for payment is obtained from the user. Then in step 620, user database is updated with the results of the above steps. This includes an audit trail of the above steps for use as needed. This storage of the classification, risk assessment, and pricing information also allows for later subsequent utilization by the user in the future. For example, if the user had not accepted the quote for services, this allows that user to revisit the quote for possible acceptance at a later date, although the quote may be updated using any additional information gleaned by the data acquisition system, by additional or improved information obtained about the user, by an improvement in the models utilized for risk assessment and quotation, etc.

FIG. 6B provides a high level flow diagram 650 of the operation of the performance monitoring engine in which various embodiments of the present disclosure may be implemented. FIG. 6B is described below with the embodiment described with reference to performance monitoring engine 570 of FIG. 5 above. Performance monitoring engine 570 is utilized to continue training and testing alternative models not yet in production (also referred to herein as shadow models) with the same data utilized by the production models of modeling engine 540. This allows for a comparison of results of the shadow models against the production models as a feedback loop. The below is described as a linear process, however, much of this can occur over time as the data becomes available.

In a first step 652, performance monitoring engine 570 may capture certain user data identified or developed pursuant to a user inquiry, which may collected in parameter collection 571. For example, a user may claim to have a certain number of employees and each shadow payroll model may adjust that (likely in differing amounts of adjustment for each model) based on other data such as from the potential user database. Then in step 654, performance monitoring engine 570 may capture updated user data that is more definitive, which may collected in label collection 572. For example, a later assessment of the user such as through an audit or other more definitive technique may yield a more definitive accounting of the user payroll described with reference to step 652. Steps 652 and 654 may occur in parallel whenever user data is updated with more definitive data.

Then in step 656, the differences between the parameter data form each model and the label data would be utilized by shadow model scoring 574 as one sample for scoring the shadow models against each other and against the production models. Steps 652-656 may be repeated over a period of time until a statistically significant difference may be apparent. Then in step 658, this scoring could be summarized by solution quality reporting 576 for use in identifying whether a current production model may be degrading over time and whether a shadow model may be performing better than a production model. In such a case, then in step 660, a shadow model may be promoted by model promotion 578 to the production environment by model deployment manager 560. In summary, this process of reviewing the ongoing performance of the production models against shadow models is a feedback loop that provides an automated system of modeling risk and pricing for services that can continuously improve over time with more experience.

FIG. 7 provides a high level flow diagram 700 of the operation of the modeling engine, the performance monitoring engine and the model development engine as a feedback loop in which various embodiments of the present disclosure may be implemented. FIG. 7 is described below with the embodiment described with reference to FIG. 5 above. For purposes of simplifying the description below, there is no differentiation between a new or returning customer. In summary, multiple models may be developed, trained and initially tested in model development engine 580, then tested with live production data as shadow models in performance monitoring engine 570, with the results compared over time against other the other shadow models as well as the production models. This comparison of results can result in production models being replaced by shadow models that have statistically significant better results over time. Based on this process and the learnings of which models perform best over time, better models can be developed, trained and initially tested in model development engine 580 and the process of testing and replacing models repeated. This is a dynamic feedback loop that can result in a continuously improving process of assessing risks and quoting services to cover the assessed risks. The below is described as a linear process, however, these steps may be performed concurrently for continuous improvement of modeling results.

In a first step 701, a request is received for a service quote for a user or user's business. This request may be as a real-time response to a user inquiry, a third party inquiry on behalf of a user, or for a potential user as part of providing an unsolicited offer to that potential user. Then in step 705, modeling engine 540 generates a quote for the user in response to the request such as described above. Subsequently in step 710, performance monitoring engine 570 trains and tests shadow models not yet in production with the same data utilized by the production models of modeling engine 540. This may be performed in real-time or later such as in batches when more processing time is readily available without affecting the performance of modeling engine 540. In step 715, the results of the models in modeling engine 540 are compared with the results of the shadow models in performance monitoring engine 570. Generally these results may be stored and tracked over time, but any outlier results that exceed a threshold may be flagged as an anomaly and may require human intervention, particularly if the outlier is the production model. Steps 700-715 may be repeated many times before step 720 occurs.

In step 720, user data in the user database may be updated with corrections or adjustments to a user's entry in that database, which may also be deemed an event. For example, it may be later determined that the user's payroll was larger than previously determined such as through the user providing actual payroll documentation, through an audit, or other review of a user's payroll. A correction to the user database reflecting this may be considered an event that is captured in event database 595. This allows for the system to assess and score any previous results of a payroll model based on this updated information. Other types of updates can include claims made by the user for services that were based in undesired events occurring for that user (e.g., insurance claims for accidents). Then in step 725, performance monitoring engine may utilize this updated information to statistically score the results of the shadow models and the production models. That is, each model is statistically scored based on what each model had predicted versus what was actually later determined. If there are substantially poor scores by any of the production models, then that may be flagged for immediate human intervention. Subsequently in step 730, the statistical scores are accumulated and compared. This may be performed by solution quality reporting 576. This accumulation and comparison can occur continuously or periodically. The results of this accumulation and comparison may be utilized to determine whether to promote a shadow model to production to replace or accompany a production model by model promotion 578. The results may also be utilized to identify whether a production model is degrading and may need replacing soon. Steps 720-730 may be repeated several times before step 735 occurs.

Then in step 735, the statistical scoring results of step 730 may be utilized to generate new models for initial training and testing in model development engine 580. Other new models may be generated based on other factors along with the statistical scoring results of step 730. Subsequently in step 740, the new models are tested and trained in anticipation of being promoted to shadow models. Then in step 745, new models that successfully pass training and testing are then promoted as shadow models with an eye towards promoting them to production models as described above. This closes this dynamic feedback loop that can result in a continuously improving process of assessing risks and quoting services to cover the assessed risks.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for managing risk assessment and providing services covering that assessed risk through modeling. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of risk assessment of user activities comprising:
receiving a request for a quote for services regarding a user and user activities including receiving first information regarding the user and the user activities;
utilizing the first information to automatically identify second information on-line from at least one third party regarding the user;
automatically modeling the user and the user activities based on the first information and the second information to assess risks associated with the user and the user activities of undesired events;
automatically modeling costs of the assessed risks for providing services covering the undesired events arising from the user activities; and
automatically providing the quote for the services covering the undesired events arising from the user activities.

2. The method of claim 1 wherein a production model is utilized in real-time for modeling the user and user activities and for modeling costs of the assessed risk, the production model generating first results utilized for providing the quote.

3. The method of claim 2 further comprising utilizing a shadow model for modeling the user and user activities and for modeling costs of the assessed risk, the shadow model generating second results.

4. The method of claim 3 wherein results of the production model and the shadow model are compared for a first set of statistical differences.

5. The method of claim 4 further comprising replacing the production models with the shadow model based on the first set of statistical differences.

6. The method of claim 3 further comprising receiving adjustments regarding the user; determining the effect of the user adjustments on the results and the second results, and comparing the effect for the production model and the shadow model for a second set of statistical differences.

7. The method of claim 6 further comprising replacing the production model with the shadow model based on the second set of statistical differences.

8. A computer program product for risk assessment of user activities, the computer program product comprising a computer readable storage medium having program instructions embodied therewith, the program instructions processed by a processing circuit to cause the device to perform a method comprising:
receiving a request for a quote for services regarding a user and user activities including receiving first information regarding the user and the user activities;
utilizing the first information to automatically identify second information on-line from at least one third party regarding the user;
automatically modeling the user and the user activities based on the first information and the second information to assess risks associated with the user and the user activities of undesired events;
automatically modeling costs of the assessed risks for providing services covering the undesired events arising from the user activities; and
automatically providing the quote for the services covering the undesired events arising from the user activities.

9. The computer program product of claim 8 wherein a production model is utilized in real-time for modeling the user and user activities and for modeling costs of the assessed risk, the production model generating first results utilized for providing the quote.

10. The computer program product of claim 9 further comprising utilizing a shadow model for modeling the user and user activities and for modeling costs of the assessed risk, the shadow model generating second results.

11. The computer program product of claim 10 wherein results of the production model and the shadow model are compared for a first set of statistical differences.

12. The computer program product of claim 11 further comprising replacing the production models with the shadow model based on the first set of statistical differences.

13. The computer program product of claim 10 further comprising receiving adjustments regarding the user; determining the effect of the user adjustments on the results and the second results, and comparing the effect for the production model and the shadow model for a second set of statistical differences.

14. The computer program product of claim 13 further comprising replacing the production model with the shadow model based on the second set of statistical differences.

15. A data processing system for risk assessment of user activities, the data processing system comprising:
a processor; and
a memory storing program instructions which when processed by the processor perform the steps of:
receiving a request for a quote for services regarding a user and user activities including receiving first information regarding the user and the user activities;
utilizing the first information to automatically identify second information on-line from at least one third party regarding the user;
automatically modeling the user and the user activities based on the first information and the second information to assess risks associated with the user and the user activities of undesired events;
automatically modeling costs of the assessed risks for providing services covering the undesired events arising from the user activities; and
automatically providing the quote for the services covering the undesired events arising from the user activities.

16. The data processing system of claim 15 wherein a production model is utilized in real-time for modeling the user and user activities and for modeling costs of the assessed risk, the production model generating first results utilized for providing the quote.

17. The data processing system of claim 16 further comprising utilizing a shadow model for modeling the user and user activities and for modeling costs of the assessed risk, the shadow model generating second results.

18. The data processing system of claim 17 wherein results of the production model and the shadow model are compared for a first set of statistical differences.

19. The data processing system of claim 17 further comprising receiving adjustments regarding the user; determining the effect of the user adjustments on the results and the second results, and comparing the effect for the production model and the shadow model for a second set of statistical differences.

20. The data processing system of claim 19 further comprising replacing the production model with the shadow model based on the second set of statistical differences.
